(19) United States
(12) Patent Application Publication
(10) Pub. No.: US 2023/0111908 A1
(43) Pub. Date: Apr. 13, 2023

(54) Early Stopped Traffic Response System

(71) Applicant: Ford Global Technologies, LLC, Dearborn, MI (US)

(72) Inventors: Matt Denninger, Royal Oak, MI (US); Anthony Antakli, Waterford, MI (US)

(73) Assignee: Ford Global Technologies, LLC, Dearborn, MI (US)

(21) Appl. No.: 17/497,204

(22) Filed: Oct. 8, 2021

(51) Int. Cl. B60W 60/00; G01C 21/34; H04W 4/46; G06N 20/00

(52) U.S. Cl. CPC B60W 60/0021; B60W 60/0011; G01C 21/3423; H04W 4/46; G06N 20/00; G01C 21/3415; B60W 2556/65

(57) ABSTRACT

An early stopped traffic response system includes a distributed computing system controller programmed and/or configured to reduce travel time delays caused by predictable instances of traffic stoppage associated with common carrier traffic. An early stopped traffic response system may obtain the common carrier schedule and route associated with a first crossing point or intersection, predict an estimated arrival time for the common carrier vehicle at the intersection, and determine, based on the estimated arrival time at the intersection, a time delay associated with the common carrier vehicle crossing the intersection. The early stopped traffic response system may generate a navigation plan that reroutes the delayed vehicle in advance of arrival at the intersection by predicting the common carrier arrival time. Predictive analytics may determine arrival times using common carrier databases and/or observed real-time information received via infrastructure computing systems networks, a vehicle-to-vehicle (V2V) and/or vehicle-to-infrastructure (V2I), networks, among other sources.

### BACKGROUND

Current traffic monitoring analytics systems often utilize signals from a plurality of connected reporting devices (e.g., mobile smartphones) stopped or slowed on roadways before reporting traffic slowdown and congestion to the tracking platform. Stationary and ongoing sources of traffic slowdown that persist as part of infrastructure, such as draw bridges and railway crossings, are often impassable but are not currently monitored as an ongoing source of potential or probable traffic slowdown.

Drawbridges and freight trains often delay traffic on repeating time frames and for repeating delay periods. For example, a freight train route may operate according to a repeating schedule, and may often have a regularly repeating delay time. In other aspects, publicly available databases of infrastructure information may provide usable information to inform traffic analytics systems of scheduled operation days, times, and durations.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the early stopped traffic response systems and methods disclosed herein may be implemented.

FIG. 2 illustrates an example functional schematic for a early stopped traffic response system in accordance with the present disclosure.

FIG. 3 illustrates example steps for implementing the early stopped traffic response system of FIG. 2 in accordance with the present disclosure.

FIG. 4 depicts a flow diagram of an example method for providing dynamic navigational suggestions in accordance with the present disclosure.

### DETAILED DESCRIPTION

### Overview

The present disclosure relates to navigation assistance systems, and more particularly, to an adaptable navigational assistance system for early stopped traffic response navigation management. The systems and methods disclosed herein are configured and/or programmed to reduce travel time associated with delays caused by traffic stoppage when common carriers traverse a thoroughfare. Examples of common carrier delays can include train traffic, marine vehicle traffic where a draw bridge is raised to allow the vessel, and/or similar types of delays.

An early stopped traffic response system is described that may include a distributed computing system controller programmed and/or configured to reduce travel time delays caused by predictable instances of traffic stoppage associated with common carriers traversing thoroughfares. In some embodiments, the early stopped traffic response system may determine a first route for navigating a passenger vehicle to a destination, determine a schedule for a common carrier vehicle having a planned route that intersects the first route at a first crossing point, predict an estimated arrival time for the common carrier vehicle at the first crossing point, and determine, based on the estimated arrival time at the first crossing point, a time delay associated with the common carrier vehicle. The time delay extends an approximate travel time for the passenger vehicle to reach the destination. In one example embodiment, the early stopped traffic response system may determine the time delay using common carrier databases and/or observed real-time information received via infrastructure computing systems networks, a vehicle-to-vehicle (V2V) and/or vehicle-to-infrastructure (V2I), networks, among other sources. The information may be analyzed via a predictive analytics system using historic, planned, and real-time data observed from the standpoint of a connected V2V network or V2I network. The input data may include, for example, scheduled (planned) common carrier vehicle departure times and travel velocities, and observed real-time departure, location, velocity and similar data. The system obtains the input data from the Internet. V2I networks, and from aggregated or discrete vehicle-specific information collected and aggregated using a V2V network, where onboard vehicle sensory devices or infrastructure computing systems provide sensory steps and transmit the information and data via respective networks. Planned or scheduled departure times may be obtained by retrieving them from online sources (either public or private databases) from common one or more carrier data clearinghouses that providing common carrier vehicle identifications, planned routes, schedule information, average travel velocity information, or other data. According to one example embodiment, the early stopped traffic response system may further utilize a trained machine learning algorithm to collect historic common carrier arrival times with respect to particular intersections, predict average delays experienced by through traffic at intersections along the common carrier travel routes, and predict future delay times based on day, time, route, intersection, and other relevant information. Moreover, the machine learning algorithm may determine alternate route candidates based on favorable traffic mitigation experiences observed at prior instances of use. For example, if a particular route or byway saves more time than other possible routes, the machine learning algorithm may provide a weight aspect to that route when selecting from a plurality of possible alternate routes. In another example embodiment, the early stopped traffic response system may evaluate real-time traffic situations to predict an estimated delay time associated with common carrier traffic. The early stopped traffic response system may determine that the time delay exceeds a threshold value, where the threshold value indicates a maximum time threshold for tolerable traffic delays, and provide, based on the time delay, navigation instructions that may steer around the common carrier stoppage. The early stopped traffic response system may generate an alternate route that removes the affected intersection(s) from the route plan by navigating to the destination using an alternate route. In another example embodiment, the early stopped traffic response system may identify a traffic delay using one or more of the above methods and systems, and generate instructions for one or more autonomous vehicle (AV) controllers disposed on a AV. The early stopped traffic response system may generate the alternate route and transmit to the connected AV. The AV may navigate to the destination after receiving the updated instructions from the connected server(s), with adequate time to remove the affected railway crossing or waterway crossing from the navigation plan. The early stopped traffic response system may increase positive user experiences for users by leveraging predictive analytics used with V2V. V2I, and other real-time and static data resources. The disclosed system may reduce total travel times that would otherwise be increased by delays caused by common carrier traffic. These and other advantages of the present disclosure are provided in greater detail herein.

### Illustrative Embodiments

The disclosure will be described more fully hereinafter with reference to the accompanying drawings, in which example embodiments of the disclosure are shown, and not intended to be limiting.

The early stopped traffic response systems and methods disclosed herein are configured and/or programmed to monitor and assist drivers with navigation while monitoring environmental traffic factors that may be likely to delay the traveler's arrival at their intended destination, or delay on a currently traveled road caused from common situations such as drawbridge delays or train crossing delays. The early stopped traffic response system may provide alternative routing suggestions and provide navigation assistance using information received from publicly accessible databases of train and waterway traffic, and by using other sources of real-time information such as vehicle-to-vehicle (V2V) and infrastructure-to-vehicle or vehicle-to-infrastructure (I2V/V2I) data networks.

Disclosed embodiments may further provide self-learning algorithms and connected networks that work together with a distributed computing platform to provide navigational assistance through a dynamic navigation routing system that continually monitors area traffic, identifies traffic patterns associated with traffic delays caused from railway, waterway, and other types of periodic traffic, and generates revised routes that mitigate such delays.

The disclosure will be described more fully hereinafter with reference to the accompanying drawings, in which exemplary embodiments of the disclosure are shown, and not intended to be limiting. A discussion is given first to vehicle based and distributed computing environment used to implement one or more disclosed methods.

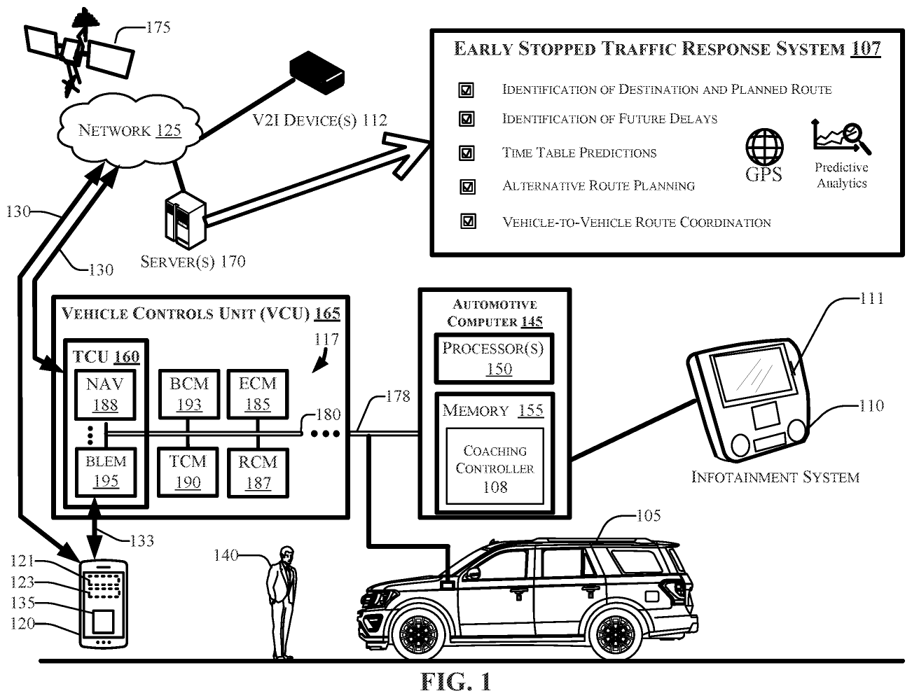

FIG. 1 depicts an example computing environment 100 that can include a vehicle 105 comprising an automotive computer 145, and a Vehicle Controls Unit (VCU) 165 that typically includes a plurality of electronic control units (ECUs) 117 disposed in communication with the automotive computer 145 and a coaching application 108 stored on a computer-readable memory 155 of the automotive computer 145. A mobile device 120, which may be associated with a user 140 and the vehicle 105, may connect with the automotive computer 145 using wired and/or wireless communication protocols and transceivers. The mobile device 120 may be communicatively coupled with the vehicle 105 via one or more network(s) 125, which may communicate via one or more wireless channel(s) 130, and/or may connect with the vehicle 105 directly using near field communication (NFC) protocols, Bluetooth® protocols, Wi-Fi, Ultra-Wide Band (UWB), and other possible data connection and sharing techniques.

The vehicle 105 may also receive signals from a Global Positioning System (GPS) 175. The GPS 175 may be a satellite system (as depicted in FIG. 1) such as the global navigation satellite system (GLNSS), Galileo, or navigation or other similar system. In other aspects, the GPS 175 may be a terrestrial-based navigation network. In some embodiments, the vehicle 105 may utilize a combination of GPS and Dead Reckoning responsive to determining that a threshold number of satellites are not recognized.

The automotive computer 145 may be or include an electronic vehicle controller, having one or more processor(s) 150 and memory 155. The automotive computer 145 may, in some example embodiments, be disposed in communication with the mobile device 120, and one or more server(s) 170.

The server(s) 170 may be part of a cloud-based (e.g., distributed) computing infrastructure, and may be associated with and/or include a Telematics Service Delivery Network (TSDN) that provides digital data services to the vehicle 105 and other vehicles (not shown in FIG. 1) that may be part of a vehicle fleet (not shown in FIG. 1). The TSDN may include and/or be associated with one or more V2V and/or V2I/I2V networks.

Vehicle-to-infrastructure (V2I) technology is a communication framework that enables several vehicles to share information with a variety of devices supporting the highway system of a particular locality. These devices may include, for example, radio frequency infrared device (RFID) readers, signage, cameras, lane makers, streetlights, and parking meters among other devices (referred to herein collectively as V2I devices 112). Enabled by a system of hardware, software, and firmware, V2I communication is typically wireless and bi-directional: infrastructure components such as lane markings, road signs, and traffic lights can wirelessly provide information to the vehicle 105, and vice versa.

V2I infrastructure may be configured to work with individual vehicles or vehicle fleets connected in V2V networks. V2V communication can include wirelessly exchanging information about the speed and position of surrounding vehicles, which may include a common carrier vehicle (not shown in FIG. 1) such as a passing train, cargo ship, or other moving vehicle that operates within sensory range of the vehicle 105. V2V networks may work in systems to avoid road collisions, ease traffic congestion, and improve the environment, among other benefits.

Although illustrated as a sport utility, the vehicle 105 may take the form of another passenger or commercial automobile such as, for example, a car, a truck, a crossover vehicle, a van, a minivan, a taxi, a bus, etc., and may be configured and/or programmed to include various types of automotive drive systems. Exemplary drive systems can include various types of internal combustion engines (ICEs) powertrains having a gasoline, diesel, or natural gas-powered combustion engine with conventional drive components such as, a transmission, a drive shaft, a differential, etc.

In another configuration, the vehicle 105 may be configured as an electric vehicle (EV). More particularly, the vehicle 105 may include a battery EV (BEV) drive system, or be configured as a hybrid EV (HEV) having an independent onboard powerplant, a plug-in HEV (PHEV) that includes a HEV powertrain connectable to an external power source, and/or includes a parallel or series hybrid powertrain having a combustion engine powerplant and one or more EV drive systems. HEVs may further include battery and/or supercapacitor banks for power storage, flywheel power storage systems, or other power generation and storage infrastructure. The vehicle 105 may be further configured as a fuel cell vehicle (FCV) that converts liquid or solid fuel to usable power using a fuel cell. (e.g., a hydrogen fuel cell vehicle (HFCV) powertrain, etc.) and/or any combination of these drive systems and components.

Further, the vehicle 105 may be a manually driven vehicle, and/or be configured and/or programmed to operate in a fully autonomous (e.g., driverless) mode (e.g., level-5 autonomy) or in one or more partial autonomy modes (e.g., Level-1 through Level-4 autonomy). An autonomous vehicle (AV) having Level-1 autonomy may generally include a single automated driver assistance feature, such as steering or acceleration assistance. Adaptive cruise control is one such example of a Level-1 autonomous system that includes aspects of both acceleration and steering. Level-2 autonomy in vehicles may provide partial automation of steering and acceleration functionality, where the automated system(s) are supervised by a human driver that performs non-automated operations such as braking and other controls. Level-3 autonomy in a vehicle can provide conditional automation and control of driving features. For example. Level-3 vehicle autonomy typically includes “environmental detection” capabilities, where the vehicle can make informed decisions independently from a present driver, such as accelerating past a slow-moving vehicle, while the present driver remains ready to retake control of the vehicle if the early stopped traffic response system is unable to execute the task. Level-4 autonomy includes vehicles having high levels of autonomy that can operate independently from a human driver, but still include human controls for override operation. Level-4 automation may also enable a self-driving mode to intervene responsive to a predefined conditional trigger, such as a road hazard or a system failure. Level-5 autonomy is associated with a fully autonomous vehicle system that requires no human input for operation, and generally does not include human operational driving controls.

The early stopped traffic response system 107 may be configured and/or programmed to operate with a vehicle having any level of autonomous vehicle controller from a completely human-operated vehicle (Level-0 automation) to a fully-autonomous vehicle (Level 5 automation). The traffic response system 107 may detect stopped or soon-to-stop traffic caused by traversing common carrier vehicles, determine alternate routes for connected vehicles that may avoid the stoppage, and provide the alternate route information to the vehicle 105 NAV system such that the route plan is updated to increase efficiency by steering around the problem area and saving overall drive time.

For example, the early stopped traffic response system 107 may communicate with an AV controller onboard the vehicle 105, provide an updated route that removes an affected intersection that will imminently be a source for stopped traffic on the original route to the destination, and guide the vehicle 105 to the destination by removing the affected intersection or crossing point from the navigation plan. The system 107 may remove the crossing point by sending the vehicle along a route that either crosses at a second (unaffected) crossing point such as an overpass that crosses over the path of the common carrier vehicle, or a second crossing point that allows the vehicle 105 to reach the destination by crossing over the common carrier vehicle route in advance of the arrival of the common carrier vehicle reaching the second crossing point.

The traffic response system 107 may be functional as part of an onboard infotainment and navigation system, and/or be operative with one or more mobile devices operated by a system user. One such example device can include the mobile device 120.

The mobile device 120 generally includes a memory 123 for storing program instructions associated with an application 135 that, when executed by a mobile device processor 121, performs aspects of the disclosed embodiments. The application (or “app”) 135 may be part of the early stopped traffic response system 107, may instantiate a user interface for interacting with the early stopped traffic response system 107, and may provide information to and/or receive information from the early stopped traffic response system 107.

In some aspects, the mobile device 120 may communicate with the vehicle 105 through one or more wireless channel(s) 130, which may be encrypted and established between the mobile device 120 and a Telematics Control Unit (TCU) 160. The mobile device 120 may communicate with the TCU 160 using a wireless transmitter (not shown in FIG. 1) associated with the TCU 160 on the vehicle 105. The transmitter may communicate with the mobile device 120 using a wireless communication network such as, for example, the one or more network(s) 125. The wireless channel(s) 130 are depicted in FIG. 1 as communicating via the one or more network(s) 125, and via one or more direct wireless connection(s) 133. The wireless connection(s) 133 may include various low-energy protocols including, for example, Bluetooth®. Bluetooth® Low-Energy (BLE), UWB, or Near Field Communication (NFC), or other protocols.

The network(s) 125 illustrate an example communication infrastructure in which the connected devices discussed in various embodiments of this disclosure may communicate. The network(s) 125 may be and/or include the Internet, a private network, public network or other configuration that operates using any one or more known communication protocols such as, for example, transmission control protocol/internet protocol (TCP/IP). Bluetooth®, BLE, Wi-Fi based on the Institute of Electrical and Electronics Engineers (IEEE) standard 802.11. UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The automotive computer 145 may be installed in an engine compartment of the vehicle 105 (or elsewhere in the vehicle 105) and operate as a functional part of the early stopped traffic response system 107, in accordance with the disclosure. The automotive computer 145 may include one or more processor(s) 150 and a computer-readable memory 155.

The one or more processor(s) 150 may be disposed in communication with one or more memory devices disposed in communication with the respective computing systems (e.g., the memory 155 and/or one or more external databases not shown in FIG. 1). The processor(s) 150 may utilize the memory 155 to store programs in code and/or to store data for performing aspects in accordance with the disclosure. As depicted in FIG. 1, the memory 155 may include the coaching application 108, which may cause the processor(s) 150 to perform steps described according to the disclosed embodiments. The memory 155 may be a non-transitory computer-readable memory storing a coaching controller program code. The memory 155 can include any one or a combination of volatile memory elements (e.g., dynamic random-access memory (DRAM), synchronous dynamic random access memory (SDRAM), etc.) and can include any one or more nonvolatile memory elements (e.g., erasable programmable read-only memory (EPROM)), flash memory, electronically erasable programmable read-only memory (EEPROM), programmable read-only memory (PROM), etc.

The VCU 165 may share a power bus 178, and may be configured and/or programmed to coordinate the data between vehicle 105 systems, connected servers (e.g., the server(s) 170), and other vehicles (not shown in FIG. 1) operating as part of a vehicle fleet. The VCU 165 can include or communicate with any combination of the ECUs 117, such as, for example, a Body Control Module (BCM) 193, an Engine Control Module (ECM) 185, a Transmission Control Module (TCM) 190, the TCU 160, a Restraint Control Module (RCM) 187, etc. In some aspects, the VCU 165 may control aspects of the vehicle 105, and implement one or more instruction sets received from the application 135 operating on the mobile device 120, and/or from one or more instruction sets received from the coaching application 108.

The TCU 160 can be configured and/or programmed to provide vehicle connectivity to wireless computing systems onboard and offboard the vehicle 105, such as a distributed platform operative using the server(s) 170, and may include a Navigation (NAV) receiver 188 for receiving and processing a GPS signal from the GPS 175, a BLE Module (BLEM) 195, a Wi-Fi transceiver, a UWB transceiver, and/or other wireless transceivers (not shown in FIG. 1) that may be configurable for wireless communication between the vehicle 105 and other systems, computers, and modules. The TCU 160 may be disposed in communication with the ECUs 117 by way of a bus 180. In some aspects, the TCU 160 may retrieve data and send data as a node in a CAN bus.

The BLEM 195 may establish wireless communication using Bluetooth® and BLE communication protocols by broadcasting and/or listening for broadcasts of small advertising packets, and establishing connections with responsive devices that are configured according to embodiments described herein. For example, the BLEM 195 may include Generic Attribute Profile (GATT) device connectivity for client devices that respond to or initiate GATT commands and requests and connect directly with the mobile device 120.

The bus 180 may be configured as a Controller Area Network (CAN) bus organized with a multi-master serial bus standard for connecting two or more of the ECUs 117 as nodes using a message-based protocol that can be configured and/or programmed to allow the ECUs 117 to communicate with each other. The bus 180 may be or include a high speed CAN (which may have bit speeds up to 1 Mb/s on CAN, 5 Mb/s on CAN Flexible Data Rate (CAN FD)), and can include a low-speed or fault tolerant CAN (up to 125 Kbps), which may, in some configurations, use a linear bus configuration. In some aspects, the ECUs 117 may communicate with a host computer (e.g., the automotive computer 145, the early stopped traffic response system 107, and/or the server(s) 170, etc.), and may also communicate with one another without the necessity of a host computer. The bus 180 may connect the ECUs 117 with the automotive computer 145 such that the automotive computer 145 may retrieve information from, send information to, and otherwise interact with the ECUs 117 to perform steps described according to embodiments of the present disclosure. The bus 180 may connect CAN bus nodes (e.g., the ECUs 117) to each other through a two-wire bus, which may be a twisted pair having a nominal characteristic impedance. The bus 180 may also be accomplished using other communication protocol solutions, such as Media Oriented Systems Transport (MOST) or Ethernet. In other aspects, the bus 180 may be a wireless intra-vehicle bus.

The VCU 165 may control various loads directly via the bus 180 communication or implement such control in conjunction with the BCM 193. The ECUs 117 described with respect to the VCU 165 are provided for exemplary purposes only, and are not intended to be limiting or exclusive. Control and/or communication with other control modules not shown in FIG. 1 is possible, and such control is contemplated.

In an example embodiment, the ECUs 117 may control aspects of vehicle operation and communication using inputs from human drivers (e.g., the user 140), inputs from an autonomous vehicle controller (not shown in FIG. 1), the early stopped traffic response system 107, and/or via wireless signal inputs received via the wireless connection(s) 133 from other connected devices such as the mobile device 120, among others.

The ECUs 117, when configured as nodes in the bus 180, may each include a central processing unit (CPU), a CAN controller, and/or a transceiver (not shown in FIG. 1). For example, although the mobile device 120 is depicted in FIG. 1 as connecting to the vehicle 105 via the BLEM 195, it is possible and contemplated that the wireless connection(s) 133 may also or alternatively be established between the mobile device 120 and one or more of the ECUs 117 via the respective transceiver(s) (not shown in FIG. 1) associated with the module(s).

When configured as an autonomous vehicle (AV), the ECUs 117 may further include an autonomous vehicle controller (not shown in FIG. 1). Accordingly, the system 107 may generate an alternative route that removes the affected crossing point from the original route plan, and transmit the alternative navigation instructions to the autonomous vehicle controller via the one or more wireless connections 130. In some aspects, the instructions are configured to cause the autonomous vehicle controller to guide the vehicle 105 to the destination according to the alternative navigation instructions.

The BCM 193 generally includes integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 193 may also operate as a gateway for bus and network interfaces to interact with remote ECUs (not shown in FIG. 1).

The BCM 193 may coordinate any one or more functions from a wide range of vehicle functionality, including energy management systems, alarms, vehicle immobilizers, driver and rider access authorization systems, Phone-as-a-Key (PaaK) systems, driver assistance systems, AV control systems, power windows, doors, actuators, and other functionality, etc. The BCM 193 may be configured for vehicle energy management, exterior lighting control, wiper functionality, power window and door functionality, heating ventilation and air conditioning systems, and driver integration systems. In other aspects, the BCM 193 may control auxiliary equipment functionality, and/or be responsible for integration of such functionality.

The computing system architecture of the automotive computer 145, VCU 165, and/or the early stopped traffic response system 107 may omit certain computing modules. It should be readily understood that the computing environment depicted in FIG. 1 is one example of a possible implementation according to the present disclosure, and thus, it should not be considered limiting or exclusive.

The automotive computer 145 may connect with an infotainment system 110 that may provide an interface for the navigation and GPS receiver 188, and the early stopped traffic response system 107. The infotainment system 110 may include a touchscreen interface portion 111, and may include voice recognition features, biometric identification capabilities that can identify users based on facial recognition, voice recognition, fingerprint identification, or other biological identification means. In other aspects, the infotainment system 110 may provide user identification using mobile device pairing techniques (e.g., connecting with the mobile device 120, a Personal Identification Number (PIN)) code, a password, passphrase, or other identifying means. The NAV 188 may be operable using the infotainment system 110, which may receive early stopped traffic information and provide user-selectable options for navigating the vehicle 105 in a way that mitigates or avoids unwanted traffic delays.

The early stopped traffic response system 107 may provide predictive analytics and GPS integration for identification of user destinations and planned routes, identification of future delays caused by common carrier traffic such as boats and trains passing through congested thoroughfares, provide time table predictions of times the common carrier vehicles will reach particular intersections, provide alternative route planning, and provide vehicle-to-vehicle route coordination that shares systematic benefits across an entire connected vehicle ecosystem.

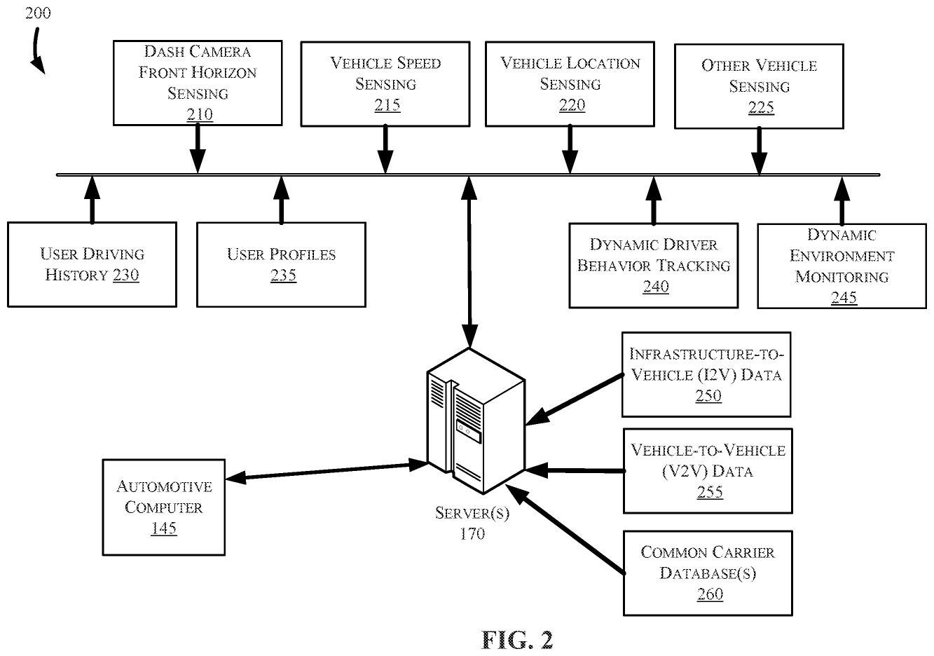

FIG. 2 illustrates an example functional schematic 200 for the early stopped traffic response system 107 (hereafter “traffic response system 107”), in accordance with the present disclosure.

The traffic response system 107 may utilize vehicle interior and exterior sensing technologies including, for example, dash camera front horizon sensing 210, vehicle speed sensing 215, vehicle location sensing 220, and/or other vehicle sensing modules 225 disposed throughout the vehicle 105. For example, the traffic response system 107 may receive sensor data from the BCM 193, the navigation and GPS receiver 188, the ECMs, the BLEM 195, and/or other ECUs 117 to determine whether a passing vehicle (e.g., a train) is indeed a train, determine an approximate travel velocity of the vehicle, and/or provide other useful information such as a count of the cars in the passing train, a report of the passing time from the first passing car to the last passing car of the common carrier vehicle, etc.

The vehicle location sensing functions 220 generally describe communication with the navigation and GPS receiver 188 to monitor an amount of time the user 140 looks at or listens to active route assisted navigation to perform turn-by-turn daily maneuvers. User driving history 230 may functionally describe a record of past trips driven by a particular user identified in user profiles 235, and record driving habits such as the user's propensity to miss turns while using navigational features, common routes and roads traveled, and usage patterns associated with days and times. For example, the traffic response system 107 may evaluate personal driving habits of the user 140 when evaluating whether an updated navigation plan will be useful for a driver. In one example embodiment, the traffic response system 107 may provide a route having fewer left turns for apprehensive drivers or inexperienced drivers, account for time of day (e.g., failing light at dusk), and/or other factors specific to user driving history 230 and/or user profiles 235.

Dynamic driver behavior tracking 240 may monitor driver engagement and provide suggestions for changing a coaching level that can include fewer or simpler navigation routs as part of the early stopped traffic response system 107, where the user 140 may optionally enable the traffic response system 107. The Traffic response system 107 may include navigational coaching features that provide variable levels of driver navigational coaching, including varying degrees of navigational help to the driver that prompt the driver to prepare for, make, and/or correct upcoming or missed turns based on observed user actions that are taken and not taken. For example, the Traffic response system 107 may provide a verbal indication stating. “Correct, this is your exit.” or “Yes, turn here.”

The dynamic environment monitoring 245 may include monitoring the operating environment both proximate the vehicle 105, and in other geographic areas that may be associated with a trip route plan. For example, the dynamic environment monitoring 245 may include steps for obtaining traffic and accident information via cloud data (not shown in FIG. 2) received in the form of I2V data 250, and/or V2V data 255.

In one or more embodiments, the traffic response system 107 may further obtain common carrier planned route information including schedules, route information, common carrier vehicle identification (ID) information, historic information of planned time and/or route deviations, and other similar information. This data is illustrated in FIG. 2 as common carrier database(s) 260.

The traffic response system 107 may obtain and/or receive the information 230-260, determine and/or predict stopped or imminently stopped traffic via the server(s) 170, and suggesting or altering a route plan to the automotive computer 145, which in some embodiments may be one of several vehicles that may not currently be stopped (such as those sharing the V2V data, for example) but are en route with enough time and distance to the problematic intersection such that the traffic response system 107 may provide guidance in the form of an updated navigational plan that avoids or mitigates delays for the user 140 and/or vehicle 105.

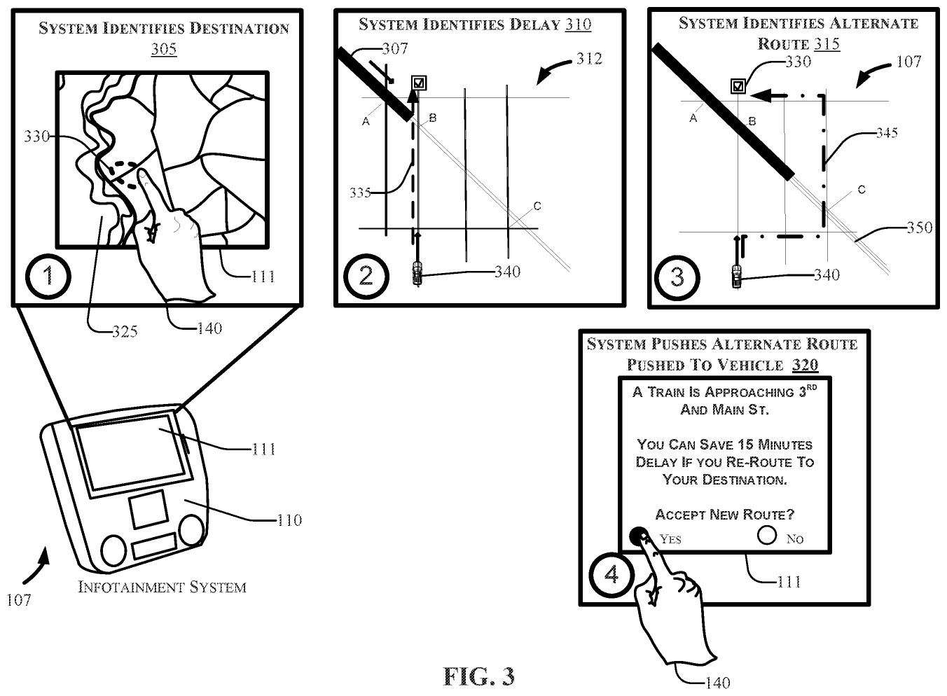

FIG. 3 illustrates example steps for implementing the early stopped traffic response system of FIGS. 1 and 2, in accordance with the present disclosure. As depicted in FIG. 2, the vehicle infotainment system 107 or other connected human-machine interface (HMI), such as the mobile device 120 (shown in FIG. 1), may provide an interactive map 325 or text entry interface (not shown) for entry of the intended destination 330. For example, the vehicle NAV system 188 (as shown in FIG. 1) may be operational as part of the traffic response system 107 to determine a route for navigating the vehicle 105 to the destination 330. The user 140 may provide system input such as a touch selection of the destination on the touchscreen interface portion 111, provide a voice instruction indicative of the destination address and/or name, a typed instruction, or some other interactive input that informs the traffic response system 107 of the intended destination 330.

Step 2 may include systematic identification of the traffic delay 310. For example, in one embodiment the traffic response system 107 may determine a schedule for a common carrier vehicle 307 associated with a common carrier route that intersects the route to the destination. The traffic response system 107 may do this in various ways, including, for example, identifying one or more intersections (depicted in FIG. 3, Step 2 as points A, B, and C on a zoom view of a sectional road map 312). The intersection(s) may be proximate to a present location 340 of the vehicle 105, and may be observed by the traffic response system 107 as having importance due to the known destination 330 and the present location 340 of the vehicle.

In one aspect, the traffic response system 107 may determine that a common carrier vehicle 307 (shown in the present example as a train) is approaching an intersection (example point B). Example point A is not currently included in the first route 335 for navigating the vehicle to the destination 330, however the intersection point A may provide information such that the traffic response system 107 may determine the presence of the common carrier vehicle 307, estimate velocity and/or travel route, and predict a time that the common carrier vehicle 307 will arrive at the intersection point B, which intervenes the present location of the vehicle 340 and the planned destination 330.

The traffic response system 107 may determine the presence of the common carrier vehicle at or near the intersection B in one or more various ways, as explained in FIG. 2. For example, the traffic response system 107 may determine the schedule for the common carrier vehicle 307 using the I2V data 250 (FIG. 2). In this example, the traffic response system 107 may receive and/or obtain the I2V data 250 from the railway computing system integrated with or controlling the railway crossing arm at intersection point A. Responsive to the common carrier vehicle 307 passing the nearby intersection point A as the train approaches point A, the railroad crossing arm (not shown) may be triggered to lower across the thoroughfare (not show) automatically as part of a traffic control system associated with the rail line and/or infrastructure. Infrastructure computing system(s) may provide a notification or signal (not shown in FIG. 3) to the traffic response system 107 that identifies the presence, trajectory, speed/velocity, and/or other information that assists the traffic response system 107 to predict an arrival time of the common carrier vehicle at future point(s) along the common carrier route (such as point B).

According to another embodiment, the traffic response system 107 may determine the presence of the common carrier vehicle 307 based on common carrier database(s) 260, which may indicate vehicle ID's, departure times, arrival times at particular waypoints along the planned travel route, planned or historic vehicle velocities, etc. This data may be predictive of future positions of the common carrier vehicle with respect to time.

In one embodiment, based on the present location 340 of the vehicle, and further based on an arrival time of the common carrier vehicle 307 to traverse the first crossing point A, the traffic response system 107 may predict an estimated arrival time for the common carrier vehicle 307 at the second crossing point B, which directly interferes with the first route for navigating the vehicle 105 to the destination 330. For example, the vehicle 105 may likely (dependent on the vehicle 105 travel speed and/or the common carrier vehicle 307 travel speed), cause all traffic at the intersection point B to stop as the train or cargo ship passes.

Additionally, there may be one or more vehicles stopped at the intersection point A to allow the train or other common carrier vehicle to pass the intersection. For example, one or more vehicles stopped proximate to crossing point A (vehicles not shown in FIG. 3) may observe, using onboard sensory devices such as RADAR. SONAR, RGB camera(s), etc. (sensory devices not shown in FIG. 3), a speed, length, start and stop time, and other information associated with the crossing position of the common carrier vehicle 307. The traffic response system 107 may determine a common carrier vehicle type (e.g., train, cargo vessel, or other marine vehicle), etc., and determine other information such as travel velocity, approximate length of the passing vehicle, time to complete passage of a particular intersection from beginning to end, etc. using one or more known techniques for characterizing vehicles and traffic variables, estimating speed, and predicting future vehicle positions. It should be appreciated by those skilled in the art that such tasks have become well known and understood in the art of autonomous vehicle navigation and guidance systems.

At Step 3, according to another embodiment, the traffic response system 107 may predict and/or determine the estimated arrival time of the common carrier vehicle 307 at the second crossing point B based on V2V network information (V2V data 255), and identify one or more alternative routes 345. The common carrier vehicle ID, velocity, trajectory, and other real-time information, alone or in conjunction with data obtained/received from the common carrier database(s) 260, may be indicative of an estimated arrival time for the common carrier vehicle 307 at the second crossing point B.

Moreover, according to one or more embodiments, this information may be used to estimate a time for the common carrier vehicle 307 to arrive at a third crossing point C, which may intersect at a future position of an alternative route 345 for the vehicle 105, and the common carrier vehicle 307 route 350 (e.g., the train track, water way, etc.). Accordingly, as shown at step 315, as a third main step, the traffic response system 107 may identify and/or generate an alternative route (Step 3) that mitigates or eliminates any stopped traffic delays for the vehicle 105 by determining, based on the estimated arrival time at the first crossing point A, a time delay associated with the common carrier vehicle 307 at a second crossing point (B or C, etc.). Because the obtained/received information may include common carrier vehicle length and time to traverse, this may be indicative of a time delay associated with the common carrier vehicle 307 traffic. The traffic response system 107 may compare the estimated delay to a predetermined threshold of tolerance for delays (e.g., a traffic delay that exceeds three minutes, five minutes, eight minutes, etc.).

As a fourth general system step, responsive to determining that the estimated delay exceeds the threshold value, the traffic response system 107 may push the alternate route (320) to the vehicle NAV system 180 (shown as step 320). The traffic response system 107 may output an alert or notification that informs the user 140 of an approaching common carrier vehicle or other similar delay, and prompt the user to provide input for changing the planned route to avoid the delay. FIG. 3 depicts the system informing the user 140 that they may save 15 minutes of delay if they re-route to their destination. The user 140 is shown selecting an affirmative response on the touchscreen interface portion 111 to receive the alternate route from the server(s) 170.

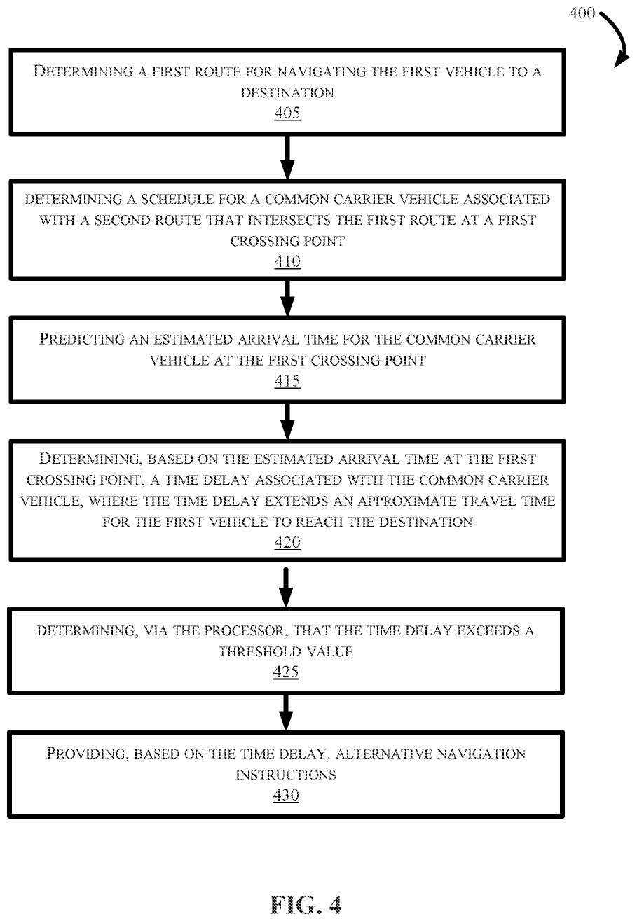

FIG. 4 is a flow diagram of an example method 400 for providing dynamic navigational suggestions using the system of FIGS. 1-3, according to embodiments of the present disclosure. FIG. 4 may be described with continued reference to prior figures, including FIGS. 1-3. The following process is exemplary and not confined to the steps described hereafter. Moreover, alternative embodiments may include more or less steps that are shown or described herein, and may include these steps in a different order than the order described in the following example embodiments.

Referring first to FIG. 4, at step 405, the method 400 may commence with determining, via a processor, a first route for navigating a first vehicle to a destination. The processor may be, for example, the server(s) 170 as shown in FIG. 1.

At step 410, the method 400 may further include determining, via the processor, a schedule for a common carrier vehicle associated with a common carrier route that intersects the first route at a first crossing point. This step may include the determining that the common carrier vehicle is a train, and the first crossing point comprises a railroad crossing. In another embodiment, this step may include determining that the common carrier vehicle is a marine vehicle, and the first crossing point comprises a drawbridge.

At step 415, the method 400 may further include predicting, via the processor, an estimated arrival time for the common carrier vehicle at the first crossing point. This step may include obtaining, via the processor, a vehicle identification (ID) associated with the common carrier vehicle, and determining, via a mass transit database, a mass transit a departure time associated with the vehicle ID. According to another embodiment, this step may include determining, via the processor, common carrier travel velocity based on the mass transit database. For example, a rail line, marine cargo line, and other common carriers are frequently operated on a predictable and set schedule. Such schedules may be made available for public and/or private use. Accordingly, the traffic response system 107 may obtain the common carrier schedule information and use the information to predict the estimated arrival time at the first or subsequent crossing points.

According to other aspects, this step may include training, via the processor, a machine learning algorithm based on historic common carrier vehicle arrival times, and determining, based on the machine learning algorithm, a predicted travel velocity for the common carrier vehicle. For example, the system may train the machine learning algorithm using known techniques such as supervised or unsupervised machine learning that takes input training data having historic vehicle IDs, vehicle routes associated with the vehicle IDs, departure time, arrival time at particular waypoints or destinations, travel velocity information, etc. The system may use the machine learning algorithm to predictively determine probable time and delay behavior based on identified patterns. Although outside the scope of the present disclosure, it should be appreciated that particular algorithm training steps for common algorithms are well known and may be omitted from the present disclosure for brevity and clarity.

In other aspects, predicting an estimated arrival time for the common carrier vehicle at the first crossing point may include receiving, via the processor, from a vehicle to vehicle (V2V) network, an observed velocity of the common carrier vehicle. For example, one or more second vehicles may observe camera and other sensory data indicative of velocity of the common carrier vehicle as they are stopped and waiting for the vehicle to pass. The V2V network data may be used either alone or in conjunction with a trained machine learning algorithm to predict the estimated arrival time at one or more crossing points subsequent to the first crossing point.

The machine learning algorithm may determine alternate route candidates based on favorable traffic mitigation experiences observed at prior instances of use. For example, if a particular route or byway saves more time than other possible routes, the machine learning algorithm may provide a weight aspect to that route when selecting from a plurality of possible alternate routes.

At step 420, the method 400 may further include determining, via the processor and based on the estimated arrival time at the first crossing point, a time delay associated with the common carrier vehicle at a second crossing point. In some aspects, the time delay extends an approximate travel time for the first vehicle to reach the destination. This step may include predicting the arrival time at the second or other subsequent crossing points with respect to the first crossing point based on travel velocity and arrival time of the common carrier vehicle at the first crossing point, determining a travel distance between the first crossing point and the second or other subsequent crossing points, determining a time delay required for the common carrier vehicle to completely traverse the first crossing point and/or the second crossing point at one or more prior times (e.g., using historic data).

At step 425, the method 400 may further include determining, via the processor, that the time delay exceeds the threshold value. This step may include setting a threshold value, and comparing the predicted delay time to the set threshold. The set threshold may be, for example, a maximum tolerated delay that may be experienced without diminishing the user's experience as they travel to their planned destination.

At step 430, the method 400 may further include providing, based on the time delay, alternative navigation instructions. This step may include generating one or more user-selectable options that can include a selective implementation of the alternate route, one or more alternate routes, etc.

The early stopped traffic response system disclosed herein may increase user experience of connected vehicles by identifying and predicting traffic delays caused by common carrier traffic that may stop the travel of the user for prolonged periods of time. Aspects of the present disclosure may improve environmental factors by mitigating vehicle idling at crossing points as the vehicle waits for cross traffic to complete, provide economy of time savings realized in commercial activities such as delivery and other industries, and decrease traffic congestion overall.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment.” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the early stopped traffic response systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for providing dynamic navigational suggestions, the method comprising:
determining, via a processor, a first route for navigating a first vehicle to a destination;
determining, via the processor, a schedule for a common carrier vehicle associated with a common carrier route that intersects the first route at a first crossing point;
predicting, via the processor, an estimated arrival time for the common carrier vehicle at the first crossing point;
determining, via the processor and based on the estimated arrival time at the first crossing point, a time delay associated with the common carrier vehicle at a second crossing point, wherein the time delay extends an approximate travel time for the first vehicle to reach the destination;
determining, via the processor, that the time delay exceeds a threshold value; and
providing, based on the time delay, alternative navigation instructions.

2. The method according to claim 1, further comprising:
providing the alternative navigation instructions to an autonomous vehicle controller disposed onboard an autonomous vehicle, wherein the instructions are configured to cause the autonomous vehicle controller to guide the autonomous vehicle to the destination according to the alternative navigation instructions.

3. The method according to claim 1, wherein determining the estimated arrival time for the common carrier vehicle traversing comprises:
obtaining, via the processor, a vehicle identification (ID) associated with the common carrier vehicle; and
determining, via a mass transit database, a mass transit a departure time associated with the vehicle ID.

4. The method according to claim 3, further comprising:
determining, via the processor, common carrier travel velocity based on the mass transit database.

5. The method according to claim 1, wherein the common carrier vehicle is a train, and the first crossing point comprises a railroad crossing.

6. The method according to claim 1, wherein the common carrier vehicle is a marine vehicle, and the first crossing point comprises a drawbridge.

7. The method according to claim 1, wherein predicting the estimated arrival time for the common carrier vehicle at the first crossing point comprises:
determining, via the processor, a travel velocity for the common carrier vehicle.

8. The method according to claim 6, further comprising:
receiving, via the processor, from a vehicle-to-vehicle (V2V) network, an observed velocity of the common carrier vehicle.

9. The method according to claim 6, further comprising:
training, via the processor, a machine learning algorithm based on historic common carrier vehicle arrival times; and
determining, based on the machine learning algorithm, a predicted travel velocity for the common carrier vehicle.

10. The method according to claim 6, wherein predicting the estimated arrival time for the common carrier vehicle at the first crossing point comprises:
receiving, from an infrastructure computing system, an arrival time of the common carrier vehicle at the first crossing point;
determining, via the processor, an estimated time for the common carrier vehicle to traverse the first crossing point;
predicting, via the processor, the estimated arrival time for the common carrier vehicle at the second crossing point;
generating, based on the time delay, an alternative route; and
transmitting alternative navigation instructions based on the alternative route to the first vehicle.

11. An early stopped traffic response system, comprising:
a processor; and
a memory for storing executable instructions, the processor programmed to execute the executable instructions to:
determine a first route for navigating a first vehicle to a destination;
determine a schedule for a common carrier vehicle associated with a common carrier route that intersects the first route at a first crossing point;
predict an estimated arrival time for the common carrier vehicle at the first crossing point;
determine, based on the estimated arrival time at the first crossing point, a time delay associated with the common carrier vehicle at a second crossing point, wherein the time delay extends an approximate travel time for the first vehicle to reach the destination;
determine that the time delay exceeds a threshold value; and
provide, based on the time delay, alternative navigation instructions.

12. The system according to claim 11, wherein the processor is further programmed to execute the instructions to:
transmit the alternative navigation instructions to an autonomous vehicle controller, wherein the instructions are configured to cause the autonomous vehicle controller to guide the autonomous vehicle to the destination according to the alternative navigation instructions.

13. The system according to claim 11, wherein the processor is further programmed to execute the instructions to:
obtain a vehicle identification (ID) associated with the common carrier vehicle; and
determine, via a mass transit database, a mass transit a departure time associated with the vehicle ID.

14. The system according to claim 13, wherein the processor is further programmed to predict the estimated arrival time for the common carrier vehicle by executing the instructions to:
determine a travel velocity based on the mass transit database.

15. The system according to claim 11, wherein the common carrier vehicle is a train.

16. The system according to claim 11, wherein the common carrier vehicle is a marine vehicle, and the first crossing point comprises a drawbridge.

17. The system according to claim 15, wherein the processor is further programmed to predict the estimated arrival time for the common carrier vehicle by executing the instructions to:
receive, from a vehicle-to-vehicle (V2V) network, an observed velocity of the common carrier vehicle.

18. The system according to claim 16, wherein the processor is further programmed to predict the estimated arrival time for the common carrier vehicle by executing the instructions to:
determine, based on a machine learning algorithm, a predicted travel velocity for the common carrier vehicle.

19. The system according to claim 16, wherein the processor is further programmed to predict the estimated arrival time for the common carrier vehicle by executing the instructions to: the estimated arrival time for the common carrier vehicle at the first crossing point comprises:
receive, from an infrastructure processor, an arrival time of the common carrier vehicle at the first crossing point;
determine an estimated time for the common carrier vehicle to traverse the first crossing point;
predict the estimated arrival time for the common carrier vehicle at the second crossing point;
generate an alternative route based on the time delay; and
transmit the alternative navigation instructions based on the alternative route to the first vehicle.

20. A non-transitory computer-readable storage medium in an early stopped traffic response system, the non-transitory computer-readable storage medium having instructions stored thereupon which, when executed by a processor, cause the processor to:
determine a first route for navigating a first vehicle to a destination;
determine a schedule for a common carrier vehicle having a planned route that intersects the first route at a first crossing point;
predict an estimated arrival time for the common carrier vehicle at the first crossing point;
determine, based on the estimated arrival time at the first crossing point, a time delay associated with the common carrier vehicle at a second crossing point, wherein the time delay extends an approximate travel time for the first vehicle to reach the destination;
determine that the time delay exceeds a threshold value; and
provide, based on the time delay, alternative navigation instructions.
